(19) United States
(12) Patent Application Publication
(10) Pub. No.: US 2023/0239921 A1
(43) Pub. Date: Jul. 27, 2023

(54) CHANNEL ACCESS FAILURE INFORMATION ON SHARED SPECTRUM

(71) Applicant: QUALCOMM Incorporated, San Diego, CA (US)

(72) Inventors: Rajeev KUMAR, San Diego, CA (US); Ozcan OZTURK, San Diego, CA (US); Pravjyot Singh DEOGUN, Bengaluru (IN); Shankar KRISHNAN, San Diego, CA (US); Xipeng ZHU, San Diego, CA (US); Gavin Bernard HORN, La Jolla, CA (US)

(21) Appl. No.: 18/001,308

(22) PCT Filed: Jun. 8, 2021
(86) PCT No.: PCT/US2021/036460

§ 371 Date: Dec. 9, 2022

(30) Foreign Application Priority Data
Aug. 7, 2020 (IN) 202041033795

(51) Int. Cl. H04W 74/08; H04W 24/10; H04W 72/0457

(52) U.S. Cl. CPC H04W 74/0808; H04W 24/10; H04W 72/0457; H04W 74/0875

(57) ABSTRACT

Aspects of the present disclosure relate to wireless communications, and more particularly, to techniques for channel access for wireless communications, for example, in unlicensed frequency bands. In some cases, a UE may log information associated with channel access failures on one or more frequency bands in shared spectrum and provide the information to a network entity.

### CROSS REFERENCE TO RELATED APPLICATION

This application hereby claims priority to Indian Application No. 202041033795, which was filed on Aug. 7, 2020, is assigned to the assignee hereof, and hereby is expressly incorporated by reference herein in its entirety as if fully set forth below and for all applicable purposes.

### INTRODUCTION

Aspects of the present disclosure relate to wireless communications, and more particularly, to techniques for sharing information regarding channel access failures on shared spectrum.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, next generation NodeB (gNB or gNodeB), TRP, etc.). A BS or DU may communicate with a set of UEs on downlink channels (e.g., for transmissions from a BS or DU to a UE) and uplink channels (e.g., for transmissions from a UE to a BS or DU).

These multiple access technologies have been adopted in various telecommunication standards to provide a common protocol that enables different wireless nodes to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between wireless communication devices.

Certain aspects provide a method for wireless communications by a user equipment (UE). The method generally includes logging information associated with channel access failures on one or more frequency bands in shared spectrum and transmitting the information to a network entity.

Certain aspects provide a method for wireless communications by a network entity. The method generally includes receiving, from a user equipment (UE), information associated with channel access failures of the UE on one or more frequency bands in shared spectrum and taking one or more actions based on the information.

Certain aspects provide a user equipment (UE). The UE generally includes means for logging information associated with channel access failures on one or more frequency bands in shared spectrum and means for transmitting the information to a network entity.

Certain aspects provide a network entity. The network entity generally includes means for receiving, from a user equipment (UE), information associated with channel access failures of the UE on one or more frequency bands in shared spectrum and means for taking one or more actions based on the information.

Certain aspects provide a user equipment (UE). The UE generally includes a processing system configured to log information associated with channel access failures on one or more frequency bands in shared spectrum and a transmitter configured to transmit the information to a network entity.

Certain aspects provide a network entity. The network entity generally includes a receiver configured to receive, from a user equipment (UE), information associated with channel access failures of the UE on one or more frequency bands in shared spectrum and a processing system configured to take one or more actions based on the information.

Certain aspects provide an apparatus for wireless communications by a user equipment. The apparatus generally includes a processing system configured to log information associated with channel access failures on one or more frequency bands in shared spectrum and an interface configured to provide the information to a network entity.

Certain aspects provide an apparatus for wireless communications by a network entity. The apparatus generally includes an interface configured to obtain, from a user equipment (UE), information associated with channel access failures of the UE on one or more frequency bands in shared spectrum and a processing system configured to take one or more actions based on the information.

Certain aspects provide a computer-readable medium for wireless communications by an apparatus. The computer-readable medium generally includes codes executable to log information associated with channel access failures on one or more frequency bands in shared spectrum; and provide the information to a network entity.

Certain aspects provide a computer-readable medium for wireless communications by an apparatus. The computer-readable medium generally includes codes executable to obtain, from a user equipment (UE), information associated with channel access failures of the UE on one or more frequency bands in shared spectrum and take one or more actions based on the information.

Aspects of the present disclosure provide UEs, network entities, means for, apparatuses, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in which certain aspects of the present disclosure may be implemented.

FIG. 2 is a block diagram conceptually illustrating a design of an example a base station (BS) and user equipment (UE), in which certain aspects of the present disclosure may be implemented.

FIG. 3A illustrates an example timing diagram for listen before talk (LBT) mechanism.

FIG. 3B illustrates example channel access rules.

FIG. 3C illustrates example frequency resources for look before talk (LBT) based channel access.

FIG. 4 illustrates example operations for wireless communication by a user equipment, in accordance with various aspects of the disclosure.

FIG. 5 illustrates example operations for wireless communication by a network entity, in accordance with various aspects of the disclosure.

FIGS. 6 and 7 illustrate examples of the types and format of information that may be logged regarding channel access failures, in accordance with aspects of the present disclosure.

FIG. 8 illustrates example components of a wireless node capable of performing the operations shown in FIG. 4, in accordance with various aspects of the disclosure.

FIG. 9 illustrates example components of a wireless node capable of performing the operations shown in FIG. 5, in accordance with various aspects of the disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for logging and sharing information regarding channel access failures, for example, on frequency bands in shared spectrum. Shared spectrum, in this context, may include unlicensed and also licensed frequency bands on which there is a medium access sharing mechanism, such as a listen before talk (LBT) mechanism.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

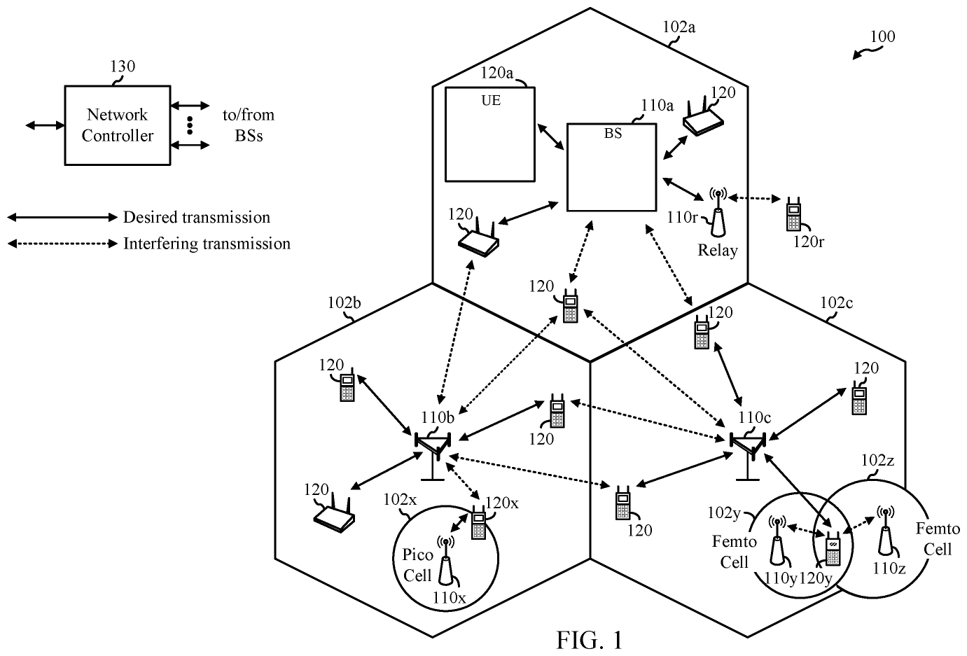

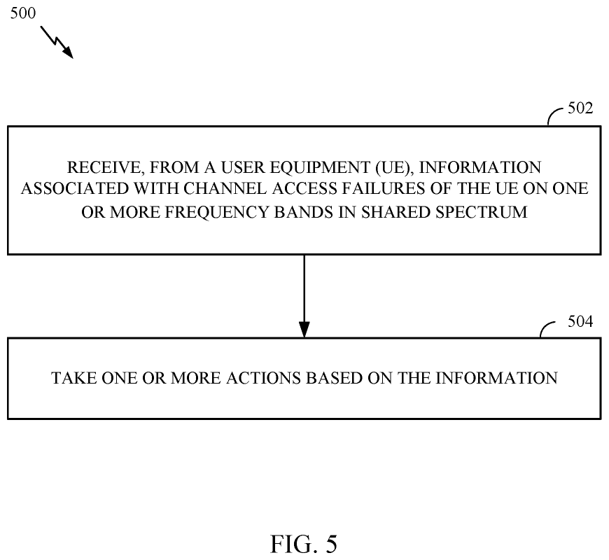

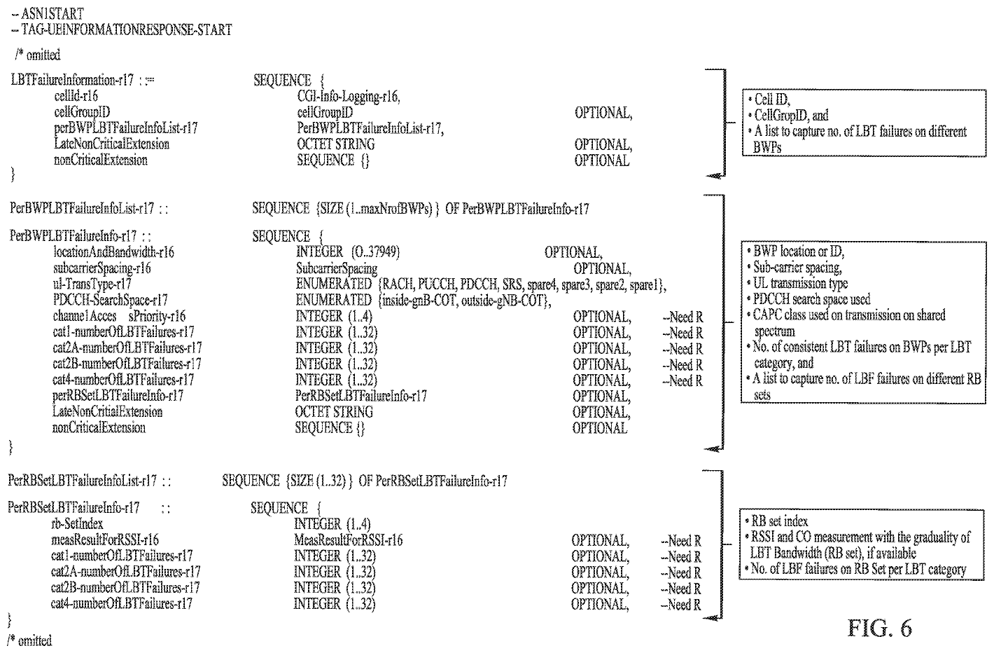

FIG. 1 illustrates an example wireless communication network 100 in which aspects of the present disclosure may be performed. For example, one or more UEs 120 in the network 100 may be configured to perform operations 400 of FIG. 4. Similarly, base stations 110 (e.g., gNBs) in the network 100 may be configured to perform operations 500 of FIG. 5.

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 20x, 120y, etc.) may be dispersed throughout the wireless communication network 100, and each UE 120 may be stationary or mobile.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

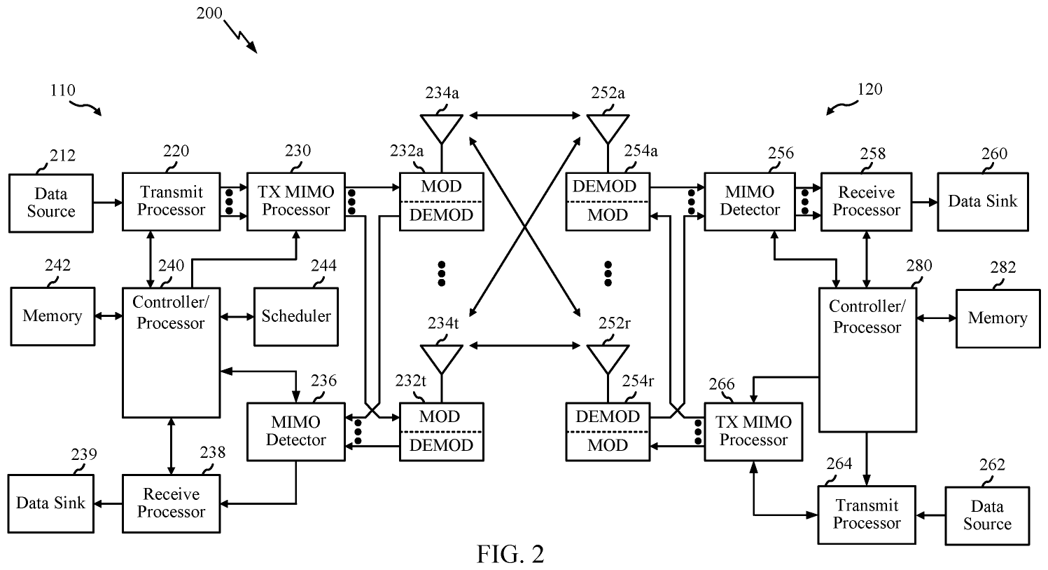

FIG. 2 illustrates example components of BS 110 and UE 120 (e.g., in the wireless communication network 100 of FIG. 1), which may be used to implement aspects of the present disclosure. For example, antennas 252, processors 266, 258, 264, and/or controller/processor 280 of the UE 120 may be configured to perform operations 400 of FIG. 4. Similarly, antennas 234, processors 220, 230, 238, and/or controller/processor 240 of the BS 110 may be configured to perform operations 500 of FIG. 5.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive downlink signals from the BS 110 or a parent IAB-node, or a child IAB-node may receive downlink signals from a parent IAB-node, and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120 or a child IAB-node, a transmit processor 264 may receive and process data (e.g., for the physical uplink shared channel (PUSCH) or the PSSCH) from a data source 262 and control information (e.g., for the physical uplink control channel (PUCCH) or the PSCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the base station 110 or a parent IAB-node.

At the BS 110 or a parent IAB-node, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The controllers/processors 240 and 280 may direct the operation at the BS 110 and the UE 120, respectively. The controller/processor 240 and/or other processors and modules at the BS 110 may perform or direct the execution of processes for the techniques described herein. The controller/processor 280 and/or other processors and modules at the UE 120 may perform or direct the execution of processes for the techniques described herein. The memories 242 and 282 may store data and program codes for BS 110 and UE 120, respectively. A scheduler 244 may schedule UEs for data transmission on the downlink and/or uplink.

As the demand for mobile broadband access continues to increase, using shared radio frequency spectrum, which may include unlicensed radio frequency spectrum, has been considered to help solve the spectrum congestion problem for future wireless needs, not only to meet the growing demand for mobile broadband access, but also to advance and enhance the user experience with mobile communications. However, the shared radio frequency spectrum may carry other transmissions, and therefore techniques such as listen before talk (LBT) and clear channel assessment (CCA) may be used in an effort prevent excessive interference.

### Example LBT Channel Access

In some scenarios where unlicensed frequency bands are used, to help achieve co-existence with other technologies a channel access mechanism referred to as Listen Before Talk (LBT) may be used. LBT generally refers to a contention-based protocol that allows users to share a wireless channel with little or no pre-coordination.

There are different types of LBT schemes, one referred to as Load Based Equipment (LBE) and another referred to as Frame Based Equipment (FBE). According to the LBE scheme, the channel sensing is performed at any time instant and random back-off is used if the channel is found busy.

According to FBE, channel sensing is performed by a base station at fixed time instants, according to a fixed frame period configuration. If the channel is busy, the base station waits a back-off period before again sensing the channel. In some scenarios, such as NR-U (NR unlicensed), the FBE mode of operation may be indicated in remaining minimum system information (RMSI) broadcasts that configure semi-static channel access. The fixed frame period (FFP) configuration may be included in a system information block (e.g., SIB-1) and/or could also be signaled for a UE with UE-specific RRC signaling for FBE secondary cell (SCell) use cases.

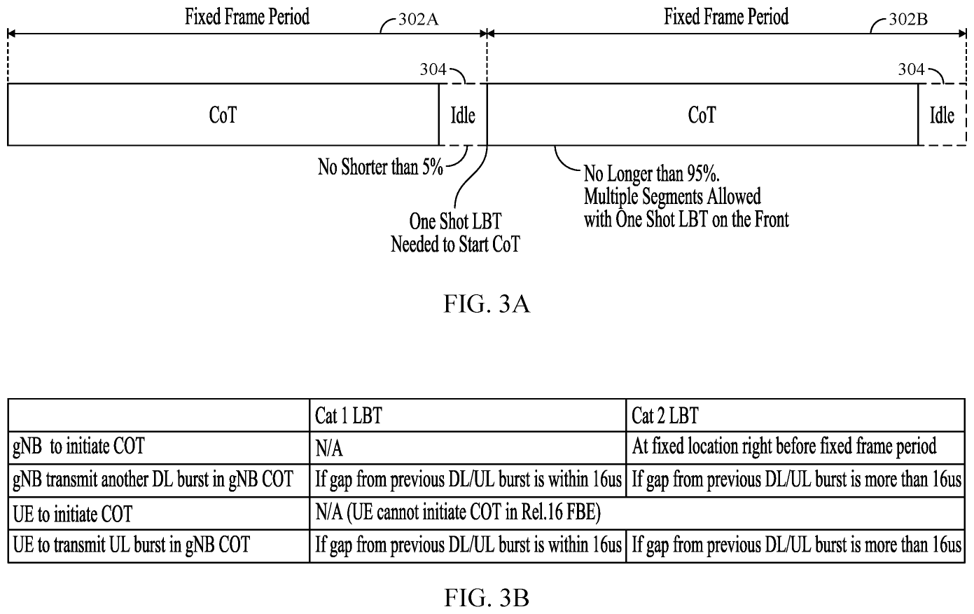

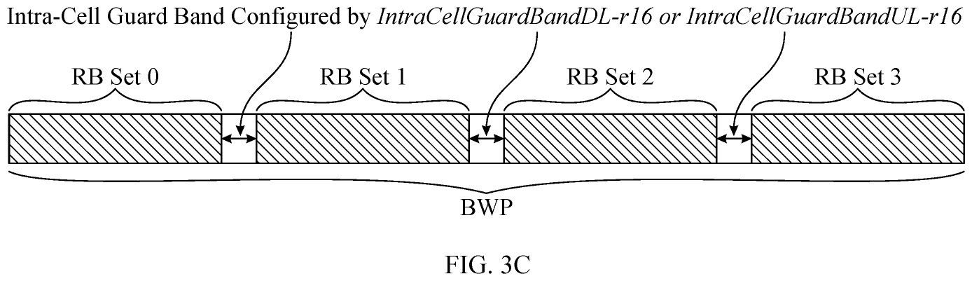

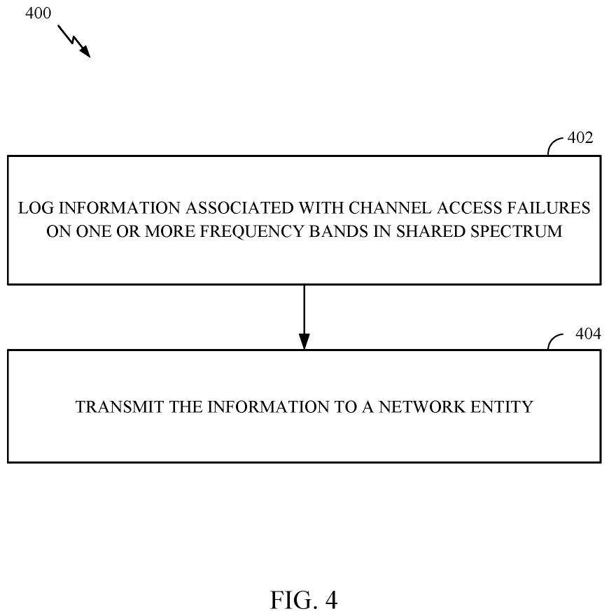

FIG. 3A illustrates an example timing diagram for FBE with fixed frame periods that include channel occupancy time (COT) and an idle period. The fixed frame period is typically restricted to one of set of values:

{1 ms,2 ms,2.5 ms,4 ms,5 ms,10 ms},

which includes the idle period. The starting positions of the FFPs within every two radio frames starts from an even radio frame and are given by i*P, where i={0,1, . . . , 20/P-1} and P is the fixed frame period (in ms). The idle period for a given subcarrier spacing (SCS) is calculated as:

ceil(Minimum idle period allowed by regulations/Ts),

where the Minimum idle period allowed is given as:

max(5% of FFP,100 us), and

Ts is the symbol duration for the given SCS. A PRACH resource is typically considered invalid if it overlaps with the IDLE period of an FFP when FBE operation is indicated. UE transmissions can occur (are allowed) within an FFP if certain downlink signals/channels (e.g., PDCCH, SSB, PBCH, RMSI, GC-PDCCH, . . . ) are detected within the FFP.

FIG. 3B illustrates example channel access rules for various types of transmissions according to different LBT categories: Cat 1 (no LBT) and Cat 2 (LBT without random backoff). As illustrated, in Rel.16 NR-U, only a base station (gNB) can act as initiating device, and a UE is only allowed to act as a responding device.

If the network indicates FBE operation, for fallback downlink and/or uplink (DL/UL) grants, for an indication of LBT type of Cat 2 (25 us) or Cat4, the UE follows a mechanism whereby one slot (e.g., a 9 microsecond slot) is measured within a 25 microsecond interval. In such cases, a 2-bit field in an LBE mode may be used to indicate an FBE LBT type, cyclic prefix (CP) extension and channel access priority class (CAPC) indication. Such a field may be re-interpreted, as fallback DCI may be used for RMSI scheduling as well, so the UE may not yet know this is an FBE system.

The rules shown in FIG. 3B may be intended to be aligned with any regulations for FBE operation. It may be noted that a Cat 2 LBT procedure for FBE may be different from a Cat 2 LBT procedure (25 us or 16 us) in LBE. For example, one measurement of 9 us before a transmission may be needed, including at least 4 us to perform the measurement.

Unlicensed bands may be used for a number of different communication service types, such as ultra-reliable low latency communications (URLLC). URLLC generally refers to a service category designed to accommodate emerging services and applications that have stringent latency and reliability requirements. URLLC may be used, for example, in industrial Internet of Things (IIoT) scenarios where devices may be assumed to communicate in a controlled environment.

What constitutes a controlled environment may vary. For example, in an extreme case, the environment may be fully controlled such that there will be no other RAT or other operators operating in the coverage. In such an environment, the LBT may virtually always pass. In this case, the system operation may be relatively straightforward. In other words, LBT may not need to be performed at all, but may be performed (e.g., for regulation compliance only), though LBT failures should not be expected.

In a more general case, with less stringent control, although a factory owner/operator may be able to control the environment somewhat, there is still a chance some other RAT is operating with non-zero probability. For example, for a WiFi device, an access probe can be transmitted from a station even when the access point is not deployed (e.g., while the owner/operator can enforce a no WiFi AP deployed in the factory floor, but it may be hard to make sure no employee brings in a device, such as their smart phone).

### Example Channel Access Failure Information for Shared Spectrum

Aspects of the present disclosure relate to wireless communications, and more particularly, to techniques for logging and sharing information regarding channel access failures, for example, on frequency bands in shared spectrum. Shared spectrum, in this context, may include unlicensed and also licensed frequency bands on which there is a medium access sharing mechanism, such as a listen before talk (LBT) mechanism.

FIG. 3C illustrates example frequency resources for LBT based channel access. As noted above, NR-Unlicensed (NR-U) utilizes Listen Before Talk (LBT) mechanism for channel access in unlicensed bands. NR-U uses 20 MHz as the basic channel access unit (referred to as LBT bandwidth).

As illustrated in FIG. 3C, the available Resource Blocks (RBs) in each LBT bandwidth is known as RB set. A BWP may consist of multiple RB sets.

A gNB may contend for the channel in a 20 MHz (LBT bandwidth) unit and provide the UE with information on time and frequency domain span of a current Channel Occupancy time. This information may be provided by expanding the role of downlink control information (DCI) format 2_0, used as a slot format indicator (SFI). To indicate frequency domain Channel Occupancy Time (COT), a bitmap may be introduced to indicate the available LBT bandwidths (valid until the end of the determined channel occupancy). To indicate time-domain COT, a duration bit-field (per serving cell) may be introduced. For “per-20 MHz” channel access, for PDCCH transmission, it may be preferred to confine each PDCCH in one 20 MHz subband and allow the UE to blindly decode PDCCH equally in each 20 MHz.

There are various scenarios that may lead to channel access failure. According to aspects presented herein, in the failure scenarios, a list of NR-U parameters can be added to existing reporting mechanisms. Examples of such mechanisms include a random access channel (RACH) report, connection establishment failure (CEF) report, and/or radio link failure (RLF) report to convey the underlying failure cause.

As LBT failures are an intrinsic occurrence in shared spectrum, such as NR-U channel access, obtaining the LBT Failure statistics can be useful for network optimization considering certain scenarios.

One example scenario is after consistent UL LBT failures on a few BWP on a Primary Cell (PCell), a UE successfully gains access to the channel (e.g., consistent UL LBT failures are detected on multiple BWPs on PCell, but eventually it did not result in an RLF). Another example scenario is after consistent UL LBT failures on a few BWP on Primary Secondary (PSCell), the UE successfully get access to the channel, i.e., consistent UL LBT failures are detected on multiple BWPs on PSCELL but eventually it did not result in a secondary cell group (SCG) Failure.

Another scenario involves consistent UL LBT failures on an SCell, which results in RLC Failure. In this case, the statistics may be useful from a core network (CN) optimization perspective.

Although LBT Failures may not be detected at the BWP level, there may be a higher number of LBT failures on certain RB sets as compared to others. Therefore, obtaining LBT Failures statistics with RB set precision within BWPs may be useful for BWP optimization.

Aspects of the present disclosure provide techniques for logging and sharing such information regarding channel access failures. There are various used cases for such channel access failure information. For example, the channel access failure information may be used to optimization of channel access (e.g., LBT failure recovery), optimal selection of bandwidth parts (BWPs) and resource block (RB) sets for uplink (UL) and downlink (DL) packet transmission. The techniques presented herein may be used together with other reporting mechanisms, such as radio link failure (RLF), connection establishment failure (CEF), and random access (RA) reports to achieve optimizations in shared spectrum, such as new radio unlicensed (NR-U) spectrum. In some cases, the information can be further shared among network entities, such as gNBs, eNBs, gNB-DUs, and gNB-CUs over X2/Xn/F1 interfaces for NR-U optimizations.

FIG. 4 illustrates example operations 400 for wireless communications by a user equipment (UE) to log and report information regarding channel access, in accordance with aspects of the present disclosure. For example, operations 400 may be performed by a UE 120 shown in FIGS. 1 and 2.

Operations 400 begin at 402, by logging information associated with channel access failures on one or more frequency bands in shared spectrum. At 404, the UE transmits the information to a network entity.

FIG. 5 illustrates example operations 500 for wireless communications by a network entity for receiving and processing information regarding channel access, in accordance with aspects of the present disclosure. For example, operations 500 may be performed by a BS 110 (e.g., a gNB) shown in FIGS. 1 and 2 communicating with a UE 120 (performing operations 400 of FIG. 4).

Operations 500 begin at 502, by receiving, from a user equipment (UE), information associated with channel access failures of the UE on one or more frequency bands in shared spectrum. At 504, the network entity takes one or more actions based on the information.

Sharing channel access (e.g., LBT) failure statistics for channel occupancy (CO) times, for different scenarios may allow for various network optimizations. In the following description, LBT is used an example of a channel access mechanism, but the techniques may be applied to any type of channel access mechanism. The channel access failure information (e.g., LBTFailureInformation) may be shared in a new report or in, at least one of, a self-organizing network (SON) container or a minimization of drive test (MDT) container, such as a logged MDT container or an immediate MDT container, to capture these statistics in the aforementioned scenarios.

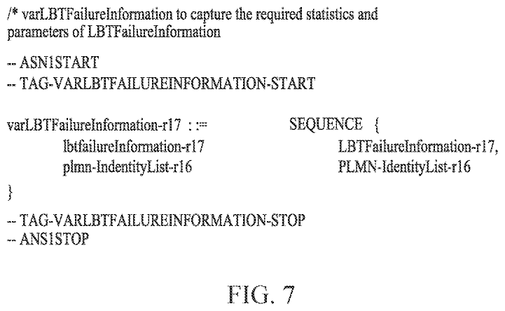

FIG. 6 illustrates an example of various fields that may be provided in LBT FailureInformation. The LBTFailureInformation may contain sufficient statistics and parameters to meet the optimization objectives discussed above.

As illustrated in FIG. 6, such information may include serving cell information and, if applicable, a cell group ID (CellGroupID). In some cases, the information may include an indication of a BWP used and number of LBT failures observed (e.g., on each of the RB sets within the BWPs and/or aggregated LBT Failures on each BW or BWP), for example, indicated by BWP location or ID and/or Sub-carrier spacing.

The information may also indicate a corresponding channel access scheme used. As noted above, such schemes may include Cat 1 (with immediate transmission after a short switching gap), cat 2A (LBT with a fixed 25 μs back-off), CAT 2B (LBT with a fixed 16 μs back-off), or cat 4 (LBT with random back-off with a contention window of variable size).

The information may also include an uplink transmission type (e.g., RACH, PUSCH, SRS, or PUCCH). The information may also include a corresponding PDCCH search space monitored for channel access (e.g., whether inside gNB COT, or outside gNB COT). The information may also indicate Channel Access Priority Class (CAPC) used for transmission on shared spectrum.

As noted, this information may indicate a number of consistent LBT failures on BWPs per LBT category and/or a list to capture a number of LBT failures on different RB sets. As illustrated, RB sets may be indicated via an RB set index. RSSI and CO measurement may be provided with a granularity of LBT Bandwidth (RB set), if available, and a number of LBT failures on RB Set per LBT category.

There are various options to determine when a UE is to start recording different fields of channel access (LBT) failure information. Such options may be designed to reduce unnecessary logging of failure information (LBT FailureInformation). According to one option, a UE may start preparing the failure information (LBTFailureInformation) report after a UE switches to a BWP a first time, for example, due to consistent UL LBT Failures on PCell or PSCell. In some cases, to capture the LBT Failure statistics on an SCell, a UE may capture the LBTFailureInformation after consistent UL LBT failures on SCell.

In some cases, a UE may use a variable (e.g., referred to as varLBTFailureInformation) for reporting of LBTFailureInformation. FIG. 7 shows an example of such a variable.

There are various options for how a UE may indicate the availability of LBTFailureInformation to the network. For example, the UE may use a flag (e.g., LBTFailureInfoAvil flag) to indicate the availability of LBTFailureInformation in different radio resource control (RRC) messages. For example, the UE could indicate the availability of LBTFailureInformation (via such a flag) in the following RRC messages: RRCSetupComplete, RRCReconfigurationComplete, RRCReestablishmentComplete, and RRCResumeComplete.

There are various options for when to report the LBTFailureInformation. In some cases, a mechanism involving request and response messages may be used. For example, upon the indication of the LBTFailureInformation availability sent by a UE, the network can request the LBTFailureInformation using a request (e.g., UEInformationRequest) message. In such cases, the UE may be configured to send the LBTFailureInformation in a response message (e.g., UEInformationResponse) if requested by the network.

In some cases, LBTFailureInformation (or other channel access type failure information) can further shared among network entities. As noted above, such information may be shared among gNBs, eNBs, gNB-DUs, and gNB-CU over X2/Xn/F1 interfaces for possible network optimizations in NR-U.

Aspects of the present disclosure provide techniques for logging and sharing such information regarding channel access failures. The techniques presented herein may be used, for example, for optimization of channel access (e.g., LBT failure recovery) in shared spectrum, optimal selection of bandwidth parts (BWPs) and resource block (RB) sets for uplink (UL) and downlink (DL) packet transmission.

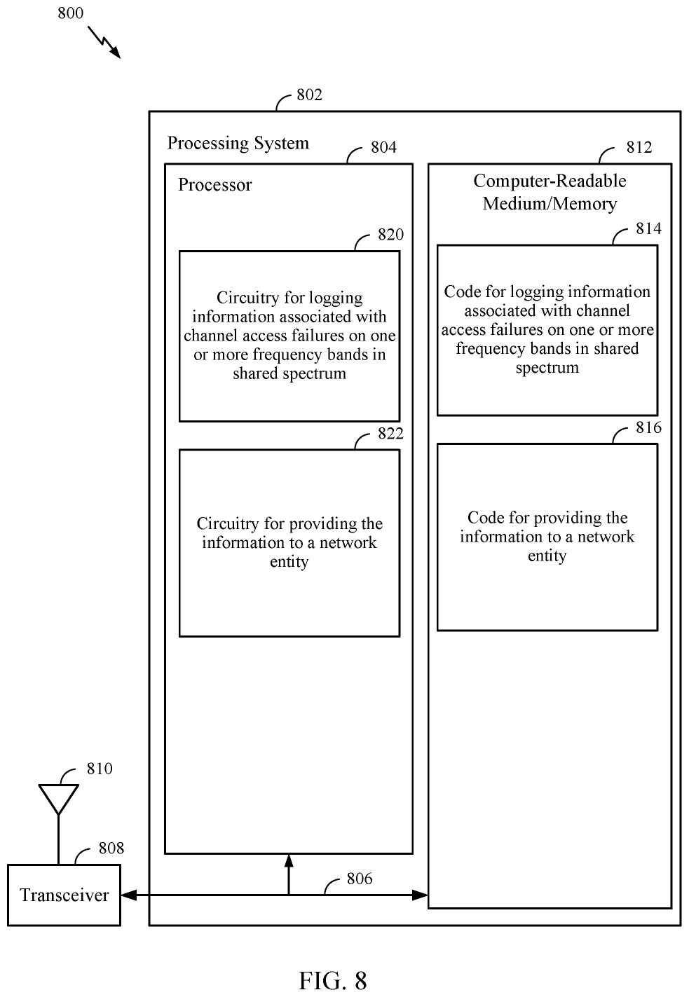

FIG. 8 illustrates a communications device 800 that may include various components (e.g., corresponding to means-plus-function components) configured to perform operations for the techniques disclosed herein, such as the operations illustrated in FIG. 4. The communications device 800 includes a processing system 802 coupled to a transceiver 808. The transceiver 808 is configured to transmit and receive signals for the communications device 800 via an antenna 810, such as the various signals as described herein. The processing system 802 may be configured to perform processing functions for the communications device 800, including processing signals received and/or to be transmitted by the communications device 800.

The processing system 802 includes a processor 804 coupled to a computer-readable medium/memory 812 via a bus 806. In certain aspects, the computer-readable medium/memory 812 is configured to store instructions (e.g., computer-executable code) that when executed by the processor 804, cause the processor 804 to perform the operations illustrated in FIG. 4. In certain aspects, computer-readable medium/memory 812 stores code 814 for logging information associated with channel access failures on one or more frequency bands in shared spectrum; and code 816 for providing the information to a network entity. In certain aspects, the processor 804 has circuitry configured to implement the code stored in the computer-readable medium/memory 812. The processor 804 includes circuitry 820 for logging information associated with channel access failures on one or more frequency bands in shared spectrum; and circuitry 822 for providing the information to a network entity.

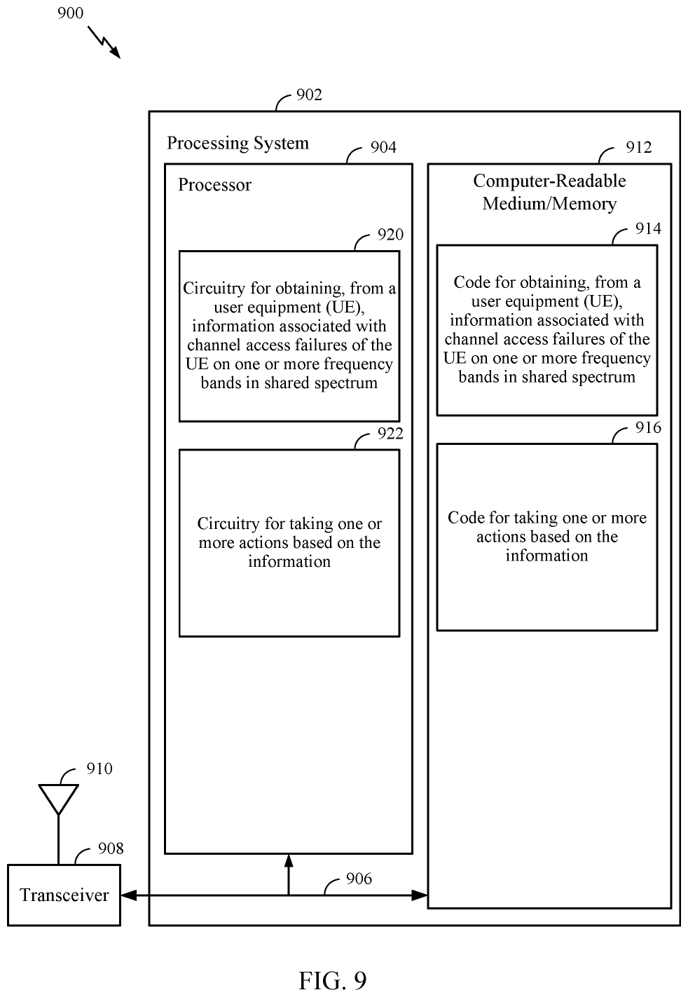

FIG. 9 illustrates a communications device 900 that may include various components (e.g., corresponding to means-plus-function components) configured to perform operations for the techniques disclosed herein, such as the operations illustrated in FIG. 5. The communications device 900 includes a processing system 902 coupled to a transceiver 908. The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., computer-executable code) that when executed by the processor 904, cause the processor 904 to perform the operations illustrated in FIG. 5. In certain aspects, computer-readable medium/memory 912 stores code 914 for obtaining, from a user equipment (UE), information associated with channel access failures of the UE on one or more frequency bands in shared spectrum; and code 916 for taking one or more actions based on the information. In certain aspects, the processor 904 has circuitry configured to implement the code stored in the computer-readable medium/memory 912. The processor 904 includes circuitry 920 for obtaining, from a user equipment (UE), information associated with channel access failures of the UE on one or more frequency bands in shared spectrum; and circuitry 922 for taking one or more actions based on the information.

### Example Aspects

Aspect 1: A method for wireless communications by a user equipment (UE), comprising: logging information associated with channel access failures on one or more frequency bands in shared spectrum; and transmitting the information to a network entity.

Aspect 2: The method of Aspect 1, wherein the channel access involves a listen before talk (LBT) mechanism.

Aspect 3: The method of claim 2, wherein the information comprises LBT failure information and is transmitted via one of a report, a self-organizing network container, and a minimization of drive test container.

Aspect 4: The method of any one of Aspects 1-3, wherein the information comprises at least one of serving cell information or a cell group identifier.

Aspect 5: The method of any one of Aspects 1-4, wherein the information comprises: an indication of one or more bandwidth parts (BWPs) used for the channel access; and a number of channel access failures observed on each of the BWPs.

Aspect 6: The method of any one of Aspects 1-5, wherein the information comprises: an indication of one or more bandwidth parts (BWPs) used for the channel access, each BWP spanning one or more resource block (RB) sets; and a number of channel access failures observed on each RB set for a BWP.

Aspect 7: The method of any one of Aspects 1-6, wherein the information comprises: an indication of one or more channel access schemes; and a number of channel access failures observed for each of the channel access schemes.

Aspect 8: The method of any one of Aspects 1-7, wherein the information comprises at least one of: an indication of one or more uplink transmission types associated with the channel access; an indication of whether a physical downlink control channel (PDCCH) search space is within a channel occupancy time (COT) of the network entity; a channel access priority class (CAPC) used for transmission on shared spectrum used for the channel access; or at least one of received signal strength indicator (RSSI), channel occupancy (CO) measurement at bandwidth or bandwidth part (BWP) used for the channel access.

Aspect 9: The method of any one of Aspects 1-8, further comprising: switching to a bandwidth part (BWP) due to uplink channel access failures on a primary cell (PCell) or primary secondary cell (PSCell), wherein logging information comprises logging information associated with the channel access failures on the BWP after the switch.

Aspect 10: The method of any one of Aspects 1-9, further comprising: observing uplink channel access failures on a secondary cell (SCell), wherein logging information comprises logging information associated with channel access failures on the secondary cell (SCell) after the observation.

Aspect 11: The method of any one of Aspects 9-10, further comprising reporting the information via a variable field, wherein the variable field includes a public land mobile network (PLMN) identifier associated with the information.

Aspect 12: The method of any one of Aspects 1-11, further comprising indicating availability of the information via at least one radio resource control (RRC) message.

Aspect 13: The method of Aspect 12, wherein the RRC message comprises at least one of an RRC setup complete message, an RRC reconfiguration complete message, an RRC reestablishment complete message, or an RRC resume complete message.

Aspect 14: The method of any one of Aspects 1-13, further comprising: receiving a request for the information from the network entity, wherein the information is transmitted to the network entity in response to the request.

Aspect 15: A method for wireless communications by a network entity, comprising: receiving, from a user equipment (UE), information associated with channel access failures of the UE on one or more frequency bands in shared spectrum; and taking one or more actions based on the information.

Aspect 16: The method of Aspect 15, wherein the channel access involves a listen before talk (LBT) mechanism.

Aspect 17: The method of claim 16, wherein, the information comprises LBT failure information and is received via one of a report, a self-organizing network container, and a minimization of drive test container

Aspect 18: The method of any one of Aspects 15-17, wherein the one or more actions involve at least one of: improving channel access failure recovery; selecting at least one of a bandwidth part (BWP) or resource block (RB) set for at least one of uplink or downlink transmissions; or sharing the information with one or more other network entities.

Aspect 19: The method of any one of Aspects 15-18, wherein the information comprises at least one of serving cell information or a cell group identifier.

Aspect 20: The method of any one of Aspects 15-19, wherein the information comprises: an indication of one or more bandwidth parts (BWPs) used for the channel access; and a number of channel access failures observed on each of the BWPs.

Aspect 21: The method of Aspect 20, wherein the information comprises: an indication of one or more bandwidth parts (BWPs) used for the channel access, each BWP spanning one or more resource block (RB) sets; and the information comprises a number of channel access failures observed on each RB set for a BWP.

Aspect 22: The method of any one of Aspects 15-21, wherein the information comprises: an indication of one or more channel access schemes; and a number of channel access failures observed for each of the channel access schemes.

Aspect 23: The method of any one of Aspects 15-22, wherein the information comprises at least one of: an indication of one or more uplink transmission types associated with the channel access; an indication of whether a physical downlink control channel (PDCCH) search space is within a channel occupancy time (COT) of the network entity; a channel access priority class (CAPC) used for transmission on shared spectrum used for the channel access; or at least one of received signal strength indicator (RSSI), channel occupancy (CO) measurement at bandwidth or bandwidth part (BWP) used for the channel access.

Aspect 24: The method of any one of Aspects 15-23, further comprising receiving, from the UE, a radio resource control (RRC) message indicating availability of the information.

Aspect 25: The method of Aspect 24, wherein the RRC message comprises at least one of an RRC setup complete message, an RRC reconfiguration complete message, an RRC reestablishment complete message, or an RRC resume complete message.

Aspect 26: The method of any one of Aspects 15-25, further comprising: transmitting to the UE a request for the information, wherein the information is received from the UE in response to the request.

Aspect 27: A user equipment, comprising at least one antenna and means for performing the operations of one or more of Aspects 1-14.

Aspect 28: A user equipment, comprising a transceiver and a processing system including at least one processor configured to perform the operations of one or more of Aspects 1-14.

Aspect 29: A network entity, comprising at least one antenna and means for performing the operations of one or more of Aspects 15-26.

Aspect 30: A network entity, comprising a transceiver and a processing system including at least one processor configured to perform the operations of one or more of Aspects 15-26.

Aspect 31: An apparatus for wireless communications by a user equipment (UE), comprising: a processing system configured to log information associated with channel access failures on one or more frequency bands in shared spectrum; and an interface configured to provide the information to a network entity.

Aspect 32: An apparatus for wireless communications by a network entity, comprising: an interface configured to obtain, from a user equipment (UE), information associated with channel access failures of the UE on one or more frequency bands in shared spectrum; and a processing system configured to take one or more actions based on the information.

Aspect 33: A computer-readable medium for wireless communications by a UE, comprising codes executable by an apparatus to: log information associated with channel access failures on one or more frequency bands in shared spectrum; and provide the information to a network entity.

Aspect 34: A computer-readable medium for wireless communications by a network entity, comprising codes executable by an apparatus to: obtain, from a user equipment (UE), information associated with channel access failures of the UE on one or more frequency bands in shared spectrum; and take one or more actions based on the information.

The techniques described herein may be used for various wireless communication technologies, such as 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably.

A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UNITS). LTE and LTE-A are releases of UNITS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2).

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

New Radio (NR) is an emerging wireless communications technology under development in conjunction with the 5G Technology Forum (5GTF). NR access (e.g., 5G NR) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices. Furthermore, the wireless node can be one of a UE, a BS and a network entity.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.8 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only network entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, processors 258, 264 and 266, and/or controller/processor 280 of the UE 120a and/or processors 220, 230, 238, and/or controller/processor 240 of the BS 110a shown in FIG. 2 may be configured to perform operations 400 of FIG. 4 and/or operations 500 of FIG. 5.

Means for receiving may include a transceiver, a receiver or at least one antenna and at least one receive processor illustrated in FIG. 2. Means for transmitting, means for sending or means for outputting may include, a transceiver, a transmitter or at least one antenna and at least one transmit processor illustrated in FIG. 2. Means for logging, means for switching, means for taking one or more actions, means for observing, means for reporting, means for performing, and means for indicating may include a processing system, which may include one or more processors, such as processors 258, 264 and 266, and/or controller/processor 280 of the UE 120a and/or processors 220, 230, 238, and/or controller/processor 240 of the BS 110a shown in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system. For example, in some cases, processors such as those shown in FIG. 2 may be configured to perform operations 400 of FIG. 4 and/or operations 500 of FIG. 5.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 4-5.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a user equipment (UE), comprising:
logging information associated with channel access failures on one or more frequency bands in shared spectrum; and
transmitting the information to a network entity.

2. The method of claim 1, wherein the channel access involves a listen before talk (LBT) mechanism.

3. The method of claim 2, wherein the information comprises LBT failure information and is transmitted via one of a report, a self-organizing network container, and a minimization of drive test container.

4. The method of claim 1, wherein the information comprises at least one of serving cell information or a cell group identifier.

5. The method of claim 1, wherein the information comprises:
an indication of one or more bandwidth parts (BWPs) used for the channel access; and
a number of channel access failures observed on each of the BWPs.

6. The method of claim 1, wherein the information comprises:
an indication of one or more bandwidth parts (BWPs) used for the channel access, each BWP spanning one or more resource block (RB) sets; and
a number of channel access failures observed on each RB set for a BWP.

7. The method of claim 1, wherein the information comprises:
an indication of one or more channel access schemes; and
a number of channel access failures observed for each of the channel access schemes.

8. The method of claim 1, wherein the information comprises at least one of:
an indication of one or more uplink transmission types associated with the channel access;
an indication of whether a physical downlink control channel (PDCCH) search space is within a channel occupancy time (COT) of the network entity;
a channel access priority class (CAPC) used for transmission on shared spectrum used for the channel access; or
at least one of received signal strength indicator (RSSI), channel occupancy (CO) measurement at bandwidth or bandwidth part (BWP) used for the channel access.

9. The method of claim 1, further comprising:
switching to a bandwidth part (BWP) due to uplink channel access failures on a primary cell (PCell) or primary secondary cell (PSCell), wherein logging information comprises logging information associated with the channel access failures on the BWP after the switch.

10. The method of claim 1, further comprising:
observing uplink channel access failures on a secondary cell (SCell), wherein logging information comprises logging information associated with channel access failures on the secondary cell (SCell) after the observation.

11. The method of either of claim 9, further comprising reporting the information via a variable field, wherein the variable field includes a public land mobile network (PLMN) identifier associated with the information.

12. The method of claim 1, further comprising indicating availability of the information via at least one radio resource control (RRC) message.

13. The method of claim 12, wherein the RRC message comprises at least one of an RRC setup complete message, an RRC reconfiguration complete message, an RRC reestablishment complete message, or an RRC resume complete message.

14. The method of claim 1, further comprising:
receiving a request for the information from the network entity, wherein the information is transmitted to the network entity in response to the request.

15. A method for wireless communications by a network entity, comprising:
receiving, from a user equipment (UE), information associated with channel access failures of the UE on one or more frequency bands in shared spectrum; and
taking one or more actions based on the information.

16. The method of claim 15, wherein, at least one of:
the channel access involves a listen before talk (LBT) mechanism; or
the information comprises LBT failure information and is received via one of a report, a self-organizing network container, and a minimization of drive test container.

17. The method of claim 15, wherein the one or more actions involve at least one of:
improving channel access failure recovery;
selecting at least one of a bandwidth part (BWP) or resource block (RB) set for at least one of uplink or downlink transmissions; or
sharing the information with one or more other network entities.

18. The method of claim 15, wherein the information comprises at least one of serving cell information or a cell group identifier.

19. The method of claim 15, wherein the information comprises:
an indication of one or more bandwidth parts (BWPs) used for the channel access; and
a number of channel access failures observed on each of the BWPs.

20. The method of claim 19, wherein the information comprises:
an indication of one or more bandwidth parts (BWPs) used for the channel access, each BWP spanning one or more resource block (RB) sets; and
the information comprises a number of channel access failures observed on each RB set for a BWP.

21. The method of claim 15, wherein the information comprises:
an indication of one or more channel access schemes; and
a number of channel access failures observed for each of the channel access schemes.

22. The method of claim 15, wherein the information comprises at least one of:
an indication of one or more uplink transmission types associated with the channel access;
an indication of whether a physical downlink control channel (PDCCH) search space is within a channel occupancy time (COT) of the network entity;
a channel access priority class (CAPC) used for transmission on shared spectrum used for the channel access; or
at least one of received signal strength indicator (RSSI), channel occupancy (CO) measurement at bandwidth or bandwidth part (BWP) used for the channel access.

23. The method of claim 15, further comprising receiving, from the UE, a radio resource control (RRC) message indicating availability of the information.

24. The method of claim 23, wherein the RRC message comprises at least one of an RRC setup complete message, an RRC reconfiguration complete message, an RRC reestablishment complete message, or an RRC resume complete message.

25. The method of claim 14, further comprising:
transmitting to the UE a request for the information, wherein the information is received from the UE in response to the request.

26. A user equipment (UE), comprising:
a processing system configured to log information associated with channel access failures on one or more frequency bands in shared spectrum; and
a transmitter configured to transmit the information to a network entity.

27. The UE of claim 26, wherein the processing system is further configured to:
switch to a bandwidth part (BWP) due to uplink channel access failures on a primary cell (PCell) or primary secondary cell (PSCell), wherein logging information comprises logging information associated with the channel access failures on the BWP after the switch.

28. The UE of claim 26, wherein the processing system is further configured to:
observe uplink channel access failures on a secondary cell (SCell), wherein logging information comprises logging information associated with channel access failures on the secondary cell (SCell) after the observation.

29. A network entity, comprising:
a receiver configured to receive, from a user equipment (UE), information associated with channel access failures of the UE on one or more frequency bands in shared spectrum; and
a processing system configured to take one or more actions based on the information.

30. The network entity of claim 29, wherein the one or more actions involve at least one of:
improving channel access failure recovery;
selecting at least one of a bandwidth part (BWP) or resource block (RB) set for at least one of uplink or downlink transmissions; or
sharing the information with one or more other network entities.
